(19) United States
(12) Patent Application Publication
(10) Pub. No.: US 2025/0358587 A1
(43) Pub. Date: Nov. 20, 2025

(54) SYSTEM FOR MANAGING AND MONITORING MOBILE AND REMOTE WORK ACTIVITIES

(71) Applicant: LocusB, Inc., Greenville, SC (US)

(72) Inventor: Anand Peddi, Greenville, SC (US)

(73) Assignee: LocusB, Inc., Greenville, SC (US)

(21) Appl. No.: 19/054,860

(22) Filed: Feb. 16, 2025

Related U.S. Application Data
(60) Provisional application No. 63/555,271, filed on Feb. 19, 2024.

(51) Int. Cl. H04W 4/021; G06F 16/245; G06F 16/29; H04W 4/02

(52) U.S. Cl. CPC H04W 4/021; G06F 16/245; G06F 16/29; H04W 4/027

(57) ABSTRACT

A system for managing mobile workforce location data includes a server and a mobile computer device. The mobile computer device collects raw location data points using one or more sensors, derives a set of filtered data points from the raw location data points based on a determination of inline and outlier data points, and transmits the set of filtered data points to the server. The server receives and processes the filtered data points, analyzes the filtered data points to determine trip information including origin, path, destination, and dwell time, and generates reports based on the trip information. The system optimizes data collection and processing to provide accurate location tracking while improving efficiency and battery life of the mobile device.

### CROSS-REFERENCE TO RELATED APPLICATIONS

This application claims priority to U.S. Provisional Application No. 63/555,271, filed Feb. 19, 2024 titled SYSTEM FOR MANAGING AND MONITORING MOBILE AND REMOTE WORK ACTIVITIES which is hereby incorporated by reference in its entirety.

### BACKGROUND

### 1) Field of the Invention

This invention is directed to a computerized system for the management and monitoring of mobile and remote work activities. When a worker has a job at a remote site, where a work activity is preformed, this system allows for the association of temporal information with location and activity for precise management and monitoring of a remote workforce. This system includes power saving features such as data capture and transmission intervals that can be determined according to the status of a mobile device, its speed, its data location accuracy and any combination.

### 2) Description of the Related Art

Tracking the locations and time spent at a location of a worker of other individual is increasingly important in that the revenue generated, efficiency at tasks, tasks themselves and behavior, without being measured, cannot be improved. Further, traditional methods of such tracking are prone to error and mistake. There are disadvantages to current systems that include the inability for precise location information based upon current location systems. For example, when a location device, such as a smart phone or other mobile device, is positioned inside, there is often no direct line from the satellite signals to the device. Therefore, the signal weakens or distorts as it travels through the building to the device that results in inaccurate operation and misleading location data. The ability for a system to determine accurate and inaccurate data is needed.

The current technologies for tracking individuals do not properly account for the travel means of that individual from an origin to a destination. The user can travel as a pedestrian, vehicle, public transportation, and any combination. The ability to track activity regardless of the location methods is a need in the industry.

Therefore, there is a need for a system that can track the locations and dwell time and associate that information with a visit or task without relying on manual operations.

Further, determining the location can be problematic given the disadvantages of current GPS system such as the inability to properly determine location when a mobile device is indoors and the resulting inaccurate information that can be provided in this circumstance.

Further, a system that improves power management by using data capture and transmission intervals would be advantageous.

Further, a system that can track activity when an individual makes a visit and arrives using both vehicle and foot transportation.

### BRIEF SUMMARY OF THE INVENTION

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The above objectives are accomplished by providing a computerized system for tracking location comprising: a mobile device in communications with a server; a set of mobile device computer readable instructions that are adapted to receive a set of raw data points, derive a set of filtered data points, transmit the set of filtered data points to a server, remote computer system and any combination; wherein the filtered data points are provided according to a determination of inline and outliners data points.

The computerized system for managing mobile location information may include a server, which is configured to receive and process location data, and a mobile computer device, which may be in communications with the server and which is configured to collect raw location data points using one or more sensors. The mobile computer device may be configured to derive a set of filtered data points from the raw location data points based on a determination of inline and outlier data points, and to transmit the set of filtered data points to the server. The server may be configured to analyze the filtered data points to determine trip information including origin, path, destination, and dwell time, and to generate reports based on the trip information.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures. The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 is a flow chart of the processes and functionality provided by the system.

FIG. 2 is a schematic of aspects of the operations of the system.

FIG. 3 is a flow chart of the information and functionality provided by the system.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to a computerized system for tracking location. The system comprises a mobile computer device in communication with a server, and utilizes a filtering process to improve location tracking accuracy and efficiency.

In some cases, the mobile device may include computer readable instructions that receive raw location data points from sensors or location systems. These instructions may derive a set of filtered data points from the raw data. The filtered data points may then be transmitted to a server or remote computer system.

The filtering process may distinguish between inline data points that likely represent actual device locations and outlier data points that may be inaccurate. By selectively including inline points and excluding outliers, the system may generate a more accurate representation of the mobile device's movements and locations visited.

In some implementations, the server may further process the filtered data to determine trip information, visit locations, dwell times, and other location-based analytics. The system may associate temporal and geographic data to enable precise management and monitoring of mobile work activities.

The computerized tracking system may provide advantages in terms of battery efficiency, data transmission optimization, and location accuracy, particularly in challenging environments like indoor spaces or areas with limited satellite visibility. By intelligently filtering and processing location data, the system aims to overcome limitations of conventional GPS-based tracking methods.

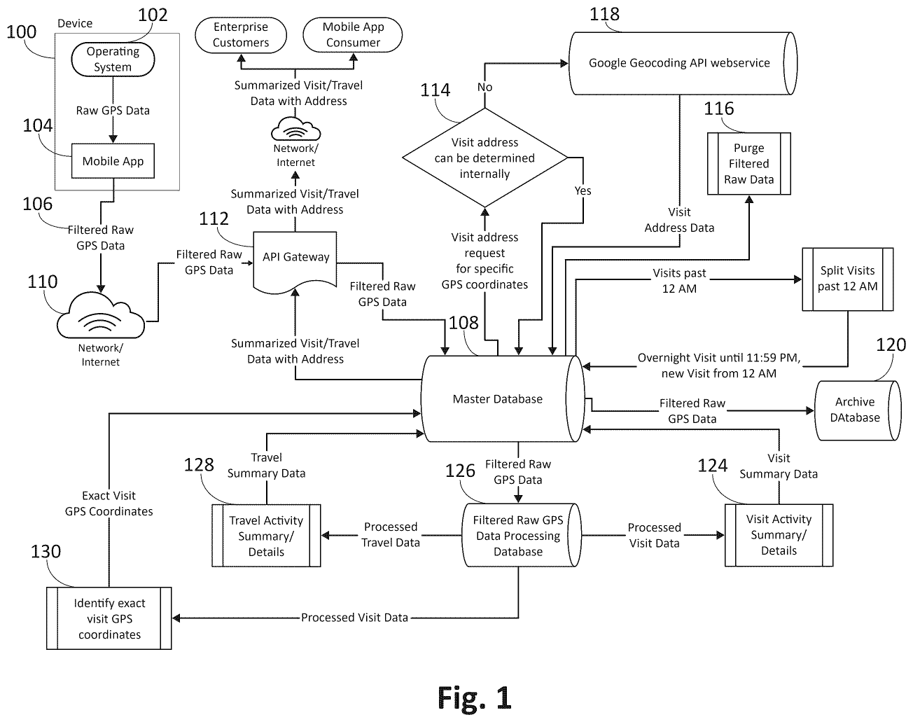

With reference to the drawings, the invention will now be described in more detail. Referring to FIG. 1, a mobile device 100 can include an operating system 102 and computer readable instructions 104 (e.g., mobile applications) that can provide the described functionality herein when processed by a processor. The mobile device can include a location system such as a GPS chip or assembly and other sensors that can determine the geographic location and additional status information of the mobile device using raw GPS data. Such sensors may include GPS, Wi-fi, accelerometer, and gyroscope to collect raw location data. The mobile device 100 may collect raw GPS data using its location sensors. This raw data may include a series of location readings, each associated with a timestamp and accuracy level.

Location data points can be collected as often as once per second so that the collection of data points can be used to determine a path of the mobile device when the data points are associated with a date and time. In some cases, the raw data may contain inaccuracies due to various factors such as signal interference or limited satellite visibility. When collecting location data, environmental conditions and other factors can impact the accuracy of the data. Further there is an inherent inaccuracy to certain mobile devices that can limit the location accuracy to the range of 5 feet or less to hundreds and even thousands of feet. Therefore, precise location may not be known for each data point collected.

The raw location (e.g., GPS data) can be subject to one or more filters to reduce the number of location data points for the applications to use. A location satellite system can transmit data continuously which can result in more data than can be used due to the volume. However, a filter can be cooperatively associated with the mobile application, server, or master database so that the raw location data is reduced. In one embodiment, there can be an initial filter included in the mobile application to filter out the raw data. The initial filter can have several modes of operation which can include filtering functionality when the mobile device is in motion and when it is stationary.

In one embodiment the raw data can be filtered at the mobile app, at the server and master database or both. The mobile application can include filtering to determine a dataset that can be used by the mobile application and transmitted to a server and database such as the master database 108. The mobile application 104 may perform initial filtering or processing on the raw location data on the mobile device 100. The filtering process determines which data points are to be included in the dataset that can then be used for the determination of location, travel, visits, activity type, and the like. This filtering process may reduce the number of data points before transmitting the information to the server. In some cases, the mobile application 104 may identify and remove obvious outliers from the dataset. As an example only, this on-device processing may account for approximately 5% of the total data analysis, with the remaining 95% occurring on a cloud server.

The initial filtering process may adapt based on the detected motion state of the mobile device 100. For example, when the mobile application 104 determines that the mobile device 100 is stationary, it may apply more stringent filtering criteria. Conversely, when motion is detected, the filtering parameters may be adjusted to account for the expected variability in location readings.

In some cases, the mobile application 104 may analyze the reported accuracy level of each GPS reading. Data points with higher accuracy may be given more weight in the filtering process, while less accurate points may be more likely to be discarded or downweighted.

In one embodiment, potentially inaccurate data can be discarded such as data that is generated when a mobile device enters a building and can produce misleading data (e.g., roofs, walls, and other construction materials attenuate and scatter the GPS signals, making it challenging for receivers to obtain accurate positional information which can produce location data that is not associated with the actual location). To improve the technology, this system uses accuracy information so that the higher the accuracy, the less frequent the data is captured at the mobile device. Data that falls in the interval is discarded so that the higher the accuracy the less data is needed.

The mobile application 104 may detect transitions between different travel modes, such as vehicle travel, walking, running, stationary, and other on-foot activities. This detection may involve analyzing multiple data attributes, including speed, acceleration patterns, and motion sensor readings. By identifying these transitions, the mobile application 104 may adjust its filtering and data collection strategies accordingly.

For instance, when the mobile application 104 detects that the user has transitioned from vehicle travel to walking, it may increase the frequency of data collection to capture more detailed movement patterns. In the contrary, it may decrease the frequency of data collection to account for the slower pace of movement. Conversely, during high-speed vehicle travel, the data collection interval may be extended to conserve battery life and reduce unnecessary data points on predictable routes.

The filtered data resulting from this initial processing may provide a more reliable representation of the user's trajectory than raw data. This refined dataset may form the basis for further processing and analysis, either on the mobile device 100 or after transmission to the server through the network interface 110.

By performing this initial filtering on the mobile device 100, the system may reduce the amount of data that needs to be transmitted to the server. This approach may help conserve network bandwidth and improve overall system efficiency. Additionally, it may allow for more timely and accurate location tracking, as the mobile application 104 can make real-time decisions about which data points are most relevant and reliable and adjust filtering accordingly.

After initial filtering of the raw data, several processing steps may be performed to extract meaningful information about user movements and visits. These steps may include travel detection, visit identification, and address determination.

The travel detection process may involve analyzing the filtered data points to determine if the mobile device 100 is in motion. In some cases, the mobile application 104 may use a combination of factors such as speed, activity type, accuracy, and distance between consecutive data points to identify travel segments. For example, if the calculated speed between two data points exceeds a predetermined threshold and the time difference between the points is greater than a certain value, the system may determine that travel has occurred.

Visit identification may be accomplished by analyzing periods of time where the mobile device 100 remains relatively stationary. In some cases, the mobile application 104 may designate an activity as “undecided” when no travel is detected but the duration does not yet meet the criteria for a visit. The system may convert an undecided activity to a visit if the stationary period extends beyond a predetermined minimum duration.

In one embodiment, the mobile device can track the location visit initiated when the user walks to the location. For example, if the user travels from a first location to a second location using a vehicle, parks the vehicle at the second location and walks to a third location some distance and time away, the third location is known to be that distance and time from the parked spot (i.e., the second location). This is an improvement to the technology, as well as the improvements stated above, as it allows for the system to track even after there is a pedestrian portion of the visit and not to show the parked spot (i.e., second location) as the destination and visit location.

To determine the addresses associated with identified visits, the system may utilize various methods. In some cases, the mobile application 104 may query the master database 108 to check if the location coordinates match a known address 114. If no match is found, the system may use external datasets, such as public map data or third-party geocoding services 118, to obtain address information for the visit location.

In one embodiment, the mobile application can determine that a sufficient number of location data points after a certain period of time that are external to the building represent actual locations (e.g., not outliers) and can include those points in the filtered data set.

The mobile device 100 may transmit filtered location data 106 to a master database 108 through a network interface 110. The database can be part of a server application or other computer readable instructions and can be accessed through an application programming interface (API) 112. The server application can receive target addresses that can be job sites, places of work, deliveries, and the like. The server application can receive the set of filtered data from the mobile device and further process the filtered data so that a set of trip information is provided. The trip information can include an origin, path, destination, dwell time, and date and time stamp. The dwell time can be for the entire trip, a segment, a location, and any combination. A client application can access the database through an API and can receive the trip information.

A master database 108 may store and manage the location and activity data received from mobile devices. In some cases, a data processor may further analyze and process the filtered location data determining if internal data can be used to establish a location 114. The data processor may purge 116 or archive processed data to a data archive 120 when it is no longer needed for immediate use.

The system may include specialized databases for different types of information. A visit database 124 may store summaries and details of visit activities. A travel database 128 may maintain records of travel activities.

A GPS processor 126 may perform additional processing on the filtered GPS data received from mobile devices. In some cases, a coordinate processor 130 may use the processed data to identify precise GPS coordinates for visit locations. The determined coordinates can be stored in the master database 108.

The system architecture allows for efficient collection, processing, and management of location data from mobile devices. By distributing processing tasks between the mobile application 104 and server-side components, the system may optimize performance and battery usage while providing accurate location tracking capabilities.

As an example in use, a home repair company may schedule a worker to arrive at a destination and the compensation can include milage traveled and the time of the task at the location required. The mobile application can receive location information, identify the path and the location, and match it to the previously visited site. In one embodiment, the address of the job site can be received when the worker has a dwell time that is consistent with the task. In one embodiment, the mobile application or service application at 114 can determine the job location when the mobile application is at a location corresponding to the job location and the mobile device is at that location for a period of time. If the job site cannot be determined from the client applications, server application or mobile applications, the job site can be determined from third party information such as Azure Maps, Google Maps, and others using an API at 116. Data from third parties can be used by the server and mobile device. The server can determine new visit locations for which the user (e.g., worker) needs to be assigned. For example, addresses for assigned visits and jobs can be retrieved and validated using third party databases so that formatted addresses and other fields can be updated, if needed, so that addresses are correct for visit activity.

Once the job, tasks, time, miles (e.g., distance), and other information is received, processed, and properly used (e.g., invoicing, records, and the like) the set of filtered data can be purged at 116. Data can also be archived at 120. Summaries and other reports can be generated at 124 from the filtered raw data processed at 126 by the master or central database. Summaries and report can include travel at 128 and visit at 124. Using the computer readable instructions described herein, a more precise location for travel, tasks, jobs, and jobs sites can be determined at 130.

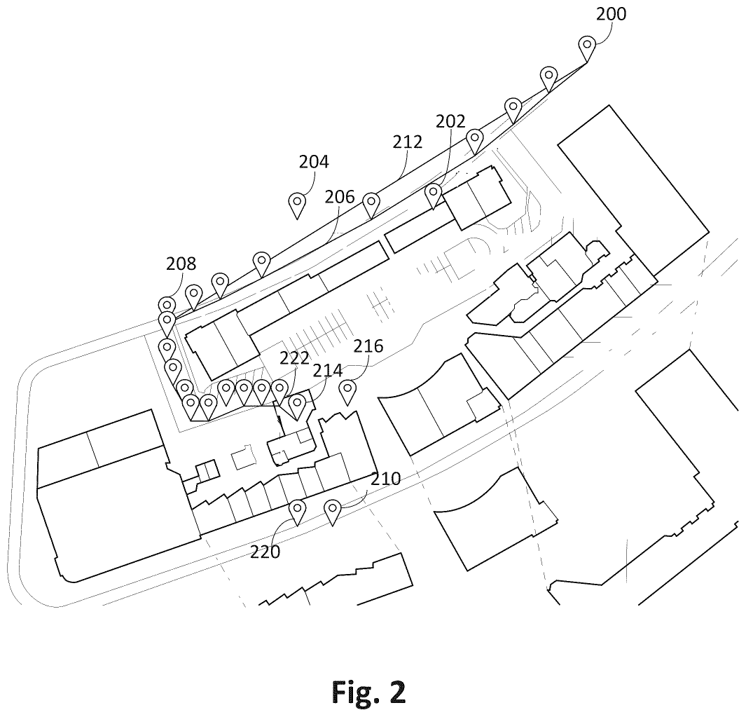

Referring to FIG. 2, an example of a set of raw location data is shown. A first point 200 can be shown that may represent the beginning of a journey. As the data points are collected, due to the inaccuracy of the data, outliers such as 202 and 204 can be present in the data set. These outliers do not represent the actual location of the mobile device and the remaining data points can be used to determine the path 206 traveled by the mobile device. The application on the mobile device can filter the set of raw data points to provide a set of filtered data points that include less data points than the raw data points. For example, points 200 and 208 can be included in the filter data set that eliminate the intervening data points thereby reducing the number and therefore file size of the set of filtered data points. Path 212 can be shown between the points 200 and 208 by using these two points without the need for a larger data set with the intervening points.

Another advantage that this system includes is the ability to increase the accuracy of the position information that is received and stored on the mobile device. When a GPS chip or assembly does not have a line of sight to the satellites, the location information can be negatively impacted. The global navigation satellite systems (GNSS) are generally not suitable to establish indoor locations, since communications signals will be attenuated and scattered by roofs, walls, and other objects. Data points can “scatter” so that while data point 214 is the true location of the mobile device, the mobile device can collect data points 216, 210 and 220 that are not accurate. The mobile device can show a geographical map that can be overlayed with the raw data points. The mobile application can determine that the mobile device entered a building 222 and that the data points received in with a period of time (e.g., a short time after the mobile device entered the building) may be inaccurate and not included in the set of filtered data points. The interference and other negative impacts on the location information can then be minimized or eliminated using the historical information and predictive computer readable instructions to determine that the entrance of a building creates inaccurate data points which can be ignored and are not added to the filtered set of data.

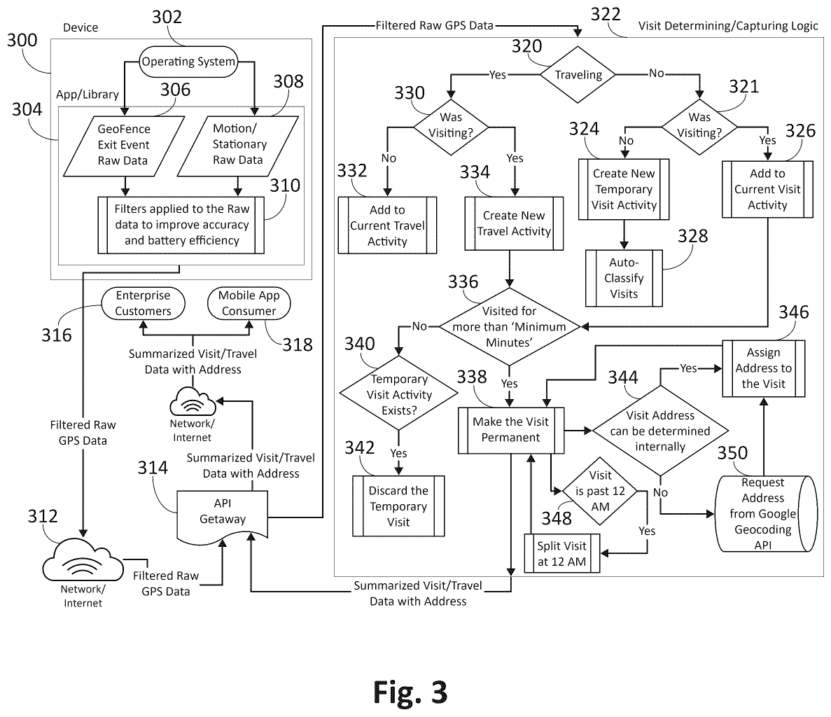

FIG. 3 illustrates the flowchart of the visit determining and capturing logic 322. The process may begin with a device 300 that includes an operating system 302 facilitating an application 304. The application 304 may process geofence data 306 and motion data 308 to determine the device's status. The application can determine if the mobile device is within a specific geofenced location or has exited that location, or if the mobile device is at rest (motionless or with slight position movement). A step 310 may involve filtering the raw position information based on geofence or motion status. The mobile application can filter the set of raw position information, according to the geofence or motion status, and provide the set of filtered data which, when transmitting and other activities, can improve efficiency, battery life and accuracy.

The filtered data may be sent through a network 312 to an API gateway 314, which may direct the data to an enterprise system 316 or another mobile application 318. A step 320 may determine if the device is traveling. If not traveling, a step 321 may check for a previous visit. Based on this check, the process may create a new temporary visit activity at step 324 or add to the current visit activity at step 326.

If a new temporary visit activity, an auto-classify visits step 328 may follow. This association can be performed using parameters taken from the mobile device, site or visit information and any combination. If the device is determined to be traveling at step 320, a step 330 may check for a previous visit. The process may then either add data to current travel activity at step 332 or create a new travel activity at step 334.

The system may evaluate if the visit duration exceeds a minimum threshold at step 336. If yes, the visit may be made permanent at step 338. If no, the process may check for an existing temporary visit at step 340 and potentially discard the temporary visit at step 342.

In one embodiment, the location (e.g., address) of the visit can be determined from information that is stored on the server or remote computer system at 344. If the address is known from these internal systems, the address can be associated with the visit at 346. If the address cannot be determined internally, the location information from the set of filtered data points can be used to determine the address from a third-party system at 350. An externally determined address may then be assigned to a visit at 346.

In some cases, the visit or time on site can cross from one day into another day as determined at 348. If so, the visit can be split into two portions representing a period on the first day and a period on the second day. In one embodiment, the visit is split at 12 AM time.

By utilizing this process flow, the system may effectively identify and categorize user movements and visits, providing valuable insights for location-based services and activity tracking.

The mobile application and server can determine if travel exists by using one or more of the following factors: speed, activity type, accuracy, functions that can be retrieved from the mobile device (e.g., accelerometers, magnetometers, change in position and other internal functionality), the distance between the previous location and the current location, and any combination. When there is an activity, it can be associated with travel using one or more criteria. For example, an activity can be designated as involving travel when the speed determined according to the time and distance between a first location and a second location is greater than a per determined speed and the time difference between the first location and the second location is greater than a predetermined period. When the current activity is a visit and a new speed is greater than a factor times a certain speed and accuracy is less than a certain value, the activity type can be determined to be travel if the locomotion is not walking, jogging, running or other “on foot” locomotion. Travel can also be determined when the current activity is between a visit and travel, the new speed is greater than a factor of the speed, accuracy is less than a certain value and the locomotion type is not “on foot.” Travel can also be determined when a new speed is greater than a value times a certain miles per hour, accuracy is less than a certain value, and locomotion type is not “on foot.” Travel can also be determined when the distance between a previous location and the new location is greater than a certain distance, and the difference between the first timestamp and the second timestamp is a certain value. Travel can also be determined, even when speed is unknown, using the distance between the previous and new locations and when that distance is greater than a certain value and the activity type is not “on foot” and motion is detected.

In one embodiment, if no travel activity is detected, the activity can be designated undecided. An undecided activity can be defined as a state between travel and visit where the non-travel activity has not reached a predetermined duration to qualify as a visit activity. In one embodiment, there can be a value that represents a minimum duration that the user can set from within the mobile app which states that unless an activity lasts for a period more than the minimum duration, it is not designated a visit activity. In one embodiment, if the current activity is undecided and travel activity is not detected for at least a “minimum duration”, the undecided activity can be designated a visit activity. If the current activity is determined to be travel, and the prior activity is undecided and the distance between previous location and the current location is between L1 and L2 distance, and difference between previous and new timestamp is greater than or equal to minimum duration, the undecided status can be converted to a visit.

In one embodiment, the filtering function can be affected by speed. When in motion, for example when the mobile device determines that that the mobile device is moving faster than a predetermined speed, such as greater than one mile per hour but less than five miles per hour, the mobile device can determine that the mobile device is likely in motion due to walking, running, or non-powered locomotion (e.g., bicycle, skateboard, and the like) or low powered locomotion (e.g., electric bicycle). Note that the range of speed (e.g., 1 to 5) can be varied in the settings of the mobile application 104. In this slower motion mode, raw data can be saved every X minutes so that a first data point is saved at X1 and a second data point is being saved at X2. The data between X1 and X2 is discarded. Therefore, the data set is reduced to improve processing without unnecessarily degrading accuracy.

Accuracy can be determined by one or more of several ways. When the data is collected, and a plot or track is determined according to the location points, outliers can be identified which indicate inaccurate data points. The higher the number of outliers the lower the accuracy. In another embodiment, the data points can be analyzed and the number of points that fall outside a standard deviation can be determined. The higher the number of data points outside the standard deviation the lower the accuracy.

In one embodiment, data at time X1 and X2 is saved and the data between X1 and X2 is discarded. The accuracy is determined and if the accuracy is deemed to be too low or drops too quickly, the data can be saved at points X1 and X3 where the time period between X1 and X2 is greater than X1 and X3. Therefore, more data points are collected in a shorter interval when the accuracy is determined to be too low. If the accuracy is higher than a predetermined level for a predetermined period of time, the time period between collected data points can be increased. If the accuracy is determined to be higher than a preset level, the data points can be collected at X1 and X4 where the time between X1 and X2 is less than X1 and X4. Some examples of the computer readable instructions and the mobile application can be represented as follows:

$$If x < a < y for data collected at {X}^{1} and {X}^{2} \qquad ( 1 )$$

where x is a lower end of an acceptable range of accuracy, a is the accuracy, and y is an upper end of an acceptable range of accuracy, data is collected at time X1 and time X2 and the data between X1 and X2 is discarded. When a drops below x for a predetermined period of time, X2 can be decreased. When a rises above y for a predetermined period of time, X2 can be increased. Therefore, the higher the accuracy of the data being recorded, the less data that needs to be recorded and the longer the data capture interval and data transmission interval can be.

In one embodiment, the initial values of X1 and X2 can be set according to the speed at which the mobile device is moving. Generally, the higher the speed in which the mobile device is moving, the time period between X1 and X2 can be lower. If it is determined that the mobile device is stationary for a predetermined period of time, data collection interval may be extended or even suspended until the mobile device resumes motion thereby conserving power when stationary. Conversely, when motion is detected, the system may increase the frequency of data collection to capture more detailed movement patterns.

In one embodiment, the period of time between the data captures can be based upon a determination whether the speed of the device that has the mobile application is stationary. The period of time can also be determined if the mobile device detects that the user is walking, or running and that movement is still detected. In one embodiment, the speed at which the mobile device is traveling can be used to determine the data capture period. For speeds that are lower, the data capture, and transmission to the server, can be at longer intervals. For example, data capture at speeds that are considered stationary or close thereto (e.g., less than 5/100 meters per second, the time between capture can be twice that of a speed that is consistent with a slow walk (e.g., 2 meters per second)). For speeds that are consistent with vehicle travel (e.g., faster than 8 miles per hour) the data capture interval can be in seconds such as every 5-30 seconds. In one embodiment, accuracy can be used to determine the data capture interval. For example, when the accuracy is in a first range and maintains its value in this range, the data capture interval (and transmission interval) can be a first interval. When the accuracy exceeds the range, the data capture interval can be shortened from the first interval. In one embodiment, when the accuracy is in a certain range, but changes within a certain percentage within the range, the data capture interval can be shorter than the first interval. In one example, the accuracy can be described in terms of a number range from 0 to 20 with 1/10 increments (with 20 being more accurate). If the range associated with the first interval is 3.5 to 4.5, and the accuracy changes by 1/20, this can trigger data capture and transmission of data. If the accuracy is near 15, for example, the interval data capture can be longer to a second interval where the second interval is longer than the first interval. When the accuracy reaches closer to the upper range, the interval can be even longer.

In one embodiment, the mobile application can include a physical location translation service which is computer readable instructions that can use the current location information and derive a physical address. The computer readable instructions can send the location information and receive or determine a physical location and from that a target for a visit. For example, the mobile application can determine that the physical location of the mobile device is at a certain latitude and longitude and that the mobile device is stationary at this location for some period of time. In one example the latitude and longitude can be 38.8 and −77.0, as well as GPS coordinates such as 34° 52′ 1.5″ N and 82° 16′ 47.9″ W. These coordinates can be associated with a physical address such as Dulany Street. Alexandria, VA or Carriage Park Cir., Greenville, SC. The address can be retrieved from a third-party source, such as through an API, including services such as Google Reverse Geocoding API and others. The address can then be used to determine the business or residence associated with that location. Therefore, the mobile application can determine the visit and associate the visit with an entity and therefore the task or job.

In one embodiment, the filtering, used for improved power consumption and processing efficiencies, can be provided with one or more filters. A first filter (e.g., initial filter) can be included in the remote computer device (e.g., mobile application on a smart phone and the like) to filter the raw data captured by the mobile device. Filtering can be provided according to the state of the mobile device such as a first state where the mobile device is stationary and a second state where the mobile device is in motion. In one embodiment, the motion can be defined as the mobile device traveling at a speed in excess of a predetermined amount. The motion status can be further described as personal to the user or through the use of a transportation system (e.g., vehicle, motorized or otherwise). For example, if the speed is determined to be greater than 0.5 miles per hour but less than 4 miles per hour, a determination can be made that the user is walking. If the speed is determined to be greater than 4.0 miles per hour but less than 6.0 miles per hour, a determination can be made that the user is jogging. If the speed is determined to be greater than 6.0 miles per hour but less than 9.0 miles per hour, a determination can be made that the user is running. If the speed is determined to be greater than 9.0 miles per hour but less than 15.0 miles per hour, a determination can be made that the user is cycling. A speed greater than 15.0 miles per hour can be associated with the user moving by use of a vehicle. It should be noted that not only the speed, but also the acceleration and duration of the speed can be used to determine the means of transportation. For example, if it is determined that the acceleration of the user is around 0.25 meters per second squared, the user can be presumed to be on a bicycle while an acceleration of 3.0 meters per second squared, it can be presumed that the user is traveling in a vehicle. Further, were the user to travel at 15 miles per hour for a few seconds and then reach 30 miles per hour, it can be presumed that the user is in a vehicle. Further, the frequency of the data saved can be impacted by the accuracy as well and as discussed above. The ability to filter the raw data allows for less data to be collected resulting in more efficient power usage, storage space, processing, and the like.

Note that these examples are illustrative and not designed to provide exact determinations of the mode of transportation.

There can also be a second filter (e.g., final filter) that can be applied to the data that is captured. With this filter, data that is transmitted to the database (e.g., after the mobile application filter) can be further filtered. In one embodiment, after the data is used for purposes, such as tracking movements, assigning costs and activities to jobs and locations, recording expenses and the like, data that includes odometer readings can be saved so travel miles from the previous visit to the current visit can be calculated. In one embodiment, all other travel data is ignored. Further, starting, and ending date time values can be saved for future usage such as regulatory and reporting functions. For data that is related to an activity that has occurred and been completed, it can be reduced to a smaller set of visit activity data (e.g., speed and accuracy values) that can be selected and summarized according to determine GPS coordinates. This set of GPS coordinates can be used to determine the address of the visit location, in one embodiment. Additionally, visit activity data can be saved for historical as well as for future usage.

The computerized system for tracking location incorporates several power management and efficiency features to optimize battery consumption and processing resources. These features are designed to balance the need for accurate location tracking with the constraints of mobile device power usage.

The mobile application may adjust data collection frequency based on the device's motion state and the accuracy of the location data being received. For example, when the mobile device is determined to be in a high-speed travel mode, such as in a vehicle, the application may reduce the frequency of data collection. This adjustment may help conserve battery power during periods when less frequent location updates are sufficient to track the device's movement.

In some cases, the system may use accuracy thresholds to determine appropriate data capture intervals. When the reported accuracy of location data falls within an acceptable range, the system may maintain a standard data collection interval. However, if the accuracy drops below a certain threshold, the system may increase the frequency of data collection to ensure that sufficient accurate data points are captured. Conversely, if the accuracy consistently exceeds a high threshold, the system may extend the data capture interval, reducing the overall number of data points collected and transmitted.

The filtering process implemented by the mobile application may contribute to improved battery life and processing efficiency. By performing initial filtering of raw location data on the mobile device, the system may reduce the amount of data that needs to be transmitted to the server. This reduction in data transmission may lead to lower power consumption associated with network usage.

In some cases, the system may implement adaptive power management strategies based on the current state of the mobile device. For example, when the battery level of the mobile device falls below a certain threshold, the system may automatically adjust to a more conservative data collection and transmission profile. This adaptive approach may help extend the operational time of the mobile device while still maintaining essential location tracking functionality.

The power management features of the system may also extend to the server-side components. By implementing efficient data processing algorithms and storage strategies, the system may reduce the computational resources required to analyze and store location data. This efficiency may contribute to overall system performance and scalability.

In some implementations, the system may utilize geofencing techniques to further optimize power usage. When the mobile device enters a predefined geofenced area, the system may adjust its data collection strategy accordingly. For example, if the device enters a known work location, the system may reduce the frequency of location updates, assuming that the device will remain relatively stationary for an extended period.

The combination of these power management and efficiency features may allow the system to provide accurate location tracking while minimizing the impact on mobile device battery life and system resources. By intelligently adapting to different usage scenarios and environmental conditions, the system may strike a balance between data accuracy and power efficiency.

The computerized system for tracking location may integrate with various enterprise systems and mobile applications to provide accurate location data and insights. In some cases, the system may offer application programming interfaces (APIs) that allow enterprise systems to access filtered location data, visit information, and travel records. These integrations may enable businesses to incorporate precise location tracking into their existing workflows and processes.

For mobile applications, the system may provide software development kits (SDKs) that developers can incorporate into their apps. These SDKs may allow third-party applications to leverage the system's advanced filtering and processing capabilities while maintaining control over the user interface and experience.

The accurate location tracking system may offer benefits across various industries and applications. In the field service industry, for example, the system may help companies optimize route planning and improve dispatch efficiency. By providing precise visit durations and travel times, the system may enable more accurate scheduling and resource allocation.

In the transportation and logistics sector, the system may enhance fleet management capabilities. Companies may use the detailed travel records and visit information to monitor driver performance, ensure compliance with regulations, and optimize delivery routes.

For retail businesses, the system may provide valuable insights into customer behavior and store performance. By analyzing visit durations and frequencies at different locations, retailers may make informed decisions about staffing, inventory management, and store layouts.

In the healthcare industry, the system may support home healthcare providers by accurately tracking caregiver visits and travel times. This information may be used for billing purposes, quality assurance, and care coordination.

For real estate professionals, the system may offer a tool for tracking property visits and time spent at different locations. This data may be used to analyze market trends, optimize property showings, and provide more accurate reporting to clients.

In the construction industry, the system may help companies monitor worker locations, track equipment usage, and manage project timelines. The accurate location data may be used to improve site safety, optimize resource allocation, and enhance project documentation.

For marketing and advertising purposes, the system may provide valuable location-based insights. Companies may use this data to analyze foot traffic patterns, measure the effectiveness of outdoor advertising, and develop targeted marketing campaigns based on user movement patterns.

In the insurance industry, the system may support usage-based insurance models by providing accurate data on vehicle usage and driving patterns. This information may be used to calculate premiums and assess risk more accurately.

For urban planning and smart city initiatives, the anonymized and aggregated location data from the system may offer insights into traffic patterns, public transportation usage, and urban mobility trends. These insights may inform infrastructure development and policy decisions.

In some cases, the system may integrate with Internet of Things (IoT) platforms, combining location data with information from other sensors and devices. This integration may enable more comprehensive monitoring and analysis of assets, environments, and processes.

The system may also support location-based authentication and security applications. By providing accurate location data, the system may enhance multi-factor authentication systems and help organizations implement geofencing-based security policies.

For personal productivity applications, the system may offer users insights into their daily routines, travel patterns, and time management. This information may be used to support habit formation, optimize schedules, and improve work-life balance.

In the hospitality industry, the system may enhance guest experiences by providing accurate location-based services within hotels and resorts. This may include features such as automated check-ins, location-based recommendations, and personalized services based on guest movements.

For event management and crowd control, the system may offer real-time insights into attendee movements and densities. This information may be used to optimize event layouts, manage queues, and enhance safety protocols.

In the field of environmental monitoring, the system may support research efforts by providing accurate location data for wildlife tracking, pollution monitoring, and ecosystem studies. The system's ability to function in challenging environments may make it particularly suitable for these applications.

By integrating with various enterprise systems and offering diverse applications across industries, the computerized system for tracking location may provide value beyond simple position tracking. The system's ability to deliver accurate, filtered, and processed location data may enable organizations to make more informed decisions, optimize operations, and develop innovative location-based services.

The sensor, or sensors, in the system of managing mobile location may include at least one of a GPS sensor, Wi-Fi sensor, accelerometer, and gyroscope. The mobile computer device may be configured to determine a motion state of the mobile computer device and to adjust a frequency of collecting raw location data points based on the determined motion state. The motion state may be determined to be one of stationary, walking, running, or vehicular travel.

Deriving a set of filtered data points may include identifying outlier data points based on a comparison to surrounding data points, and excluding the identified outlier data points from the set of filtered data points. A server in the system may be configured to determine a physical address associated with a visit location based on the filtered data points and associate the physical address with the trip information. Determining the physical address includes querying an internal database for a match to the filtered data points and if no match is found, requesting address information from a third-party geocoding service.

Another embodiment provides for a system for managing mobile location data, which may include a mobile computer device that is configured to collect raw location data points using a sensor in communication with the mobile device, and a server which is configured to receive data from the mobile device. The mobile device may derive a set of filtered data points from the raw location data points based on a determination of inline and outlier data points. The derived set of filtered data points may be transmitted to the server by the mobile device. The server may be configured to process the set of filtered data points, analyze the filtered data points to determine trip information including origin, path, destination, and dwell time, and to provide a report based on the trip information.

The mobile computer device may be further configured to determine a motion state of the mobile computer device and adjust a frequency of collecting raw location data points based on the determined motion state. The motion state may be one of stationary, walking, running, or vehicular travel. The mobile compute device may also be configured to identify outlier data points based on a comparison to surrounding data points and exclude the identified outlier data points from the set of filtered data points.

The server may be configured to determine a physical address associated with a visit location based on the filtered data points and associate the address with the trip information. The server may determine the physical address by querying an internal database for a match to the filtered data points and if no match is found, requesting address information from a third-party geocoding service. The server may split a visit that spans across midnight into two separate visit records, each associated with a different calendar day.

Another embodiment provides for a system for optimizing power consumption in mobile tracking, which may include a server configured to receive and process location data and a mobile computer device. The mobile computer device may collect raw location data points using one or more sensors, adjust data collection frequency based on detected motion state and location data accuracy, derive a set of filtered data points from the raw location data points, and transmit the set of filtered data points to the server. The server may be configured to, analyze the filtered data points to determine user movements and visits, and generate location-based insights for enterprise applications.

The mobile computer device may be further configured to determine a motion state of the mobile computer device as one of stationary, walking, running, or vehicular travel, and to adjust the data collection frequency based on the determined motion state. For instance, the mobile computer device may increase the data collection frequency when the motion state changes from stationary to walking, running, or vehicular travel. Deriving a set of filtered data points may be accomplished by identifying outlier data points based on a comparison to surrounding data points, and excluding the identified outlier data points from the set of filtered data points.

The server may be further configured to determine a physical address associated with a visit location based on the filtered data points, and associate the physical address with the user movements and visits. Determining the physical address may comprise querying an internal database for a match to the filtered data points, and if no match is found, requesting address information from a third-party geocoding service.

It is understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

A number of implementations have been described. Nevertheless, it will be understood that various modifications may be made without departing from the spirit and scope of the disclosure. Accordingly, other implementations are within the scope of the following claims.

What is claimed is:

1. A system for managing mobile location information comprising:
a server configured to receive and process location data;
a mobile computer device in communications with the server and configured to collect raw location data points using a sensor, wherein the mobile computer device is configured to:
derive a set of filtered data points from the raw location data points based on a determination of inline and outlier data points; and
transmit the set of filtered data points to the server; and
wherein the server is configured to:
analyze the filtered data points to determine trip information including origin, path, destination, and dwell time; and
generate reports based on the trip information.

2. The system of claim 1, wherein the sensor includes at least one of a GPS sensor, Wi-Fi sensor, accelerometer, and gyroscope.

3. The system of claim 1, wherein the mobile computer device is further configured to determine a motion state of the mobile computer device; and adjust a frequency of collecting raw location data points based on the determined motion state.

4. The system of claim 3, wherein the motion state is determined to be one of stationary, walking, running, or vehicular travel.

5. The system of claim 1, wherein deriving the set of filtered data points includes identifying outlier data points based on a comparison to surrounding data points; and excluding the identified outlier data points from the set of filtered data points.

6. The system of claim 1, wherein the server is configured to determine a physical address associated with a visit location based on the filtered data points and associate the physical address with the trip information.

7. The system of claim 6, wherein determining the physical address includes querying an internal database for a match to the filtered data points and if no match is found, requesting address information from a third-party geocoding service.

8. A system for managing mobile location data, comprising:
a mobile computer device configured to collect raw location data points using a sensor in communication with the mobile device, derive a set of filtered data points from the raw location data points based on a determination of inline and outlier data points, transmit the set of filtered data points to a server; and,
wherein the server is configured to process the set of filtered data points, analyze the filtered data points to determine trip information including origin, path, destination, and dwell time; and provide a report based on the trip information.

9. The system of claim 8, wherein the mobile computer device is configured to determine a motion state of the mobile computer device and adjust a frequency of collecting raw location data points based on the determined motion state.

10. The system of claim 9, wherein the motion state is determined to be one of stationary, walking, running, or vehicular travel.

11. The system of claim 8, wherein the mobile compute device is configured to identify outlier data points based on a comparison to surrounding data points and exclude the identified outlier data points from the set of filtered data points.

12. The system of claim 8, wherein the server is configured to determine a physical address associated with a visit location based on the filtered data points and associate the address with the trip information.

13. The system of claim 12, wherein the server is configured to query an internal database for a match to the filtered data points and if no match is found, requesting address information from a third-party geocoding service.

14. The system of claim 13, wherein the server is configured to split a visit that spans across midnight into two separate visit records, each associated with a different calendar day.

15. A system for optimizing power consumption in mobile tracking, comprising:
a server configured to receive and process location data;
a mobile computer device configured to:
collect raw location data points using one or more sensors;
adjust data collection frequency based on detected motion state and location data accuracy;
derive a set of filtered data points from the raw location data points; and
transmit the set of filtered data points to the server;
wherein the server is further configured to:
analyze the filtered data points to determine user movements and visits; and
generate location-based insights for enterprise applications.

16. The system of claim 15, wherein the mobile computer device is configured to determine a motion state of the mobile computer device as one of stationary, walking, running, or vehicular travel; and adjust the data collection frequency based on the determined motion state.

17. The system of claim 16, wherein the mobile computer device is configured to increase the data collection frequency when the motion state changes from stationary to walking, running, or vehicular travel.

18. The system of claim 15, wherein deriving the set of filtered data points comprises:
identifying outlier data points based on a comparison to surrounding data points; and
excluding the identified outlier data points from the set of filtered data points.

19. The system of claim 15, wherein the server is further configured to:
determine a physical address associated with a visit location based on the filtered data points; and
associate the physical address with the user movements and visits.

20. The system of claim 19, wherein determining the physical address comprises:
querying an internal database for a match to the filtered data points; and
if no match is found, requesting address information from a third-party geocoding service.
